(19) United States
(12) Patent Application Publication
(10) Pub. No.: US 2008/0036125 A1
(43) Pub. Date: Feb. 14, 2008

(54) Central Fastening Element for an Axially Symmetric Gas Spring

(76) Inventors: Ludger Burstedde, Sindelfingen (DE); Michael Guse, Stuttgart (DE); Andreas Opara, Asperg (DE); Christian Ottawa, Altdorf (DE); Hans Scheerer, Esslingen (DE)

Correspondence Address: KENYON & KENYON LLP, ONE BROADWAY, NEW YORK, NY, 10004, US

(21) Appl. No.: 10/468,176

(22) PCT Filed: Jan. 29, 2002
(86) PCT No.: PCT/EP02/00884

§ 371 Date: Dec. 1, 2004

(30) Foreign Application Priority Data
Feb. 14, 2001 (DE) 101 06 886.7

(51) Int. Cl. F16F 5/00

(52) U.S. Cl. 267/64.11; 267/182

(57) ABSTRACT

In a central fastening element for an axially symmetric, vehicle gas spring, which includes a bellows that has central bores or cutouts in the region of its end faces, the fastening element being fixed to the vehicle body, protruding from the surroundings of the attachment point in a direction normal to it, and being encompassed by the bores or cutouts. The fastening element includes a shaped stud or a shaped cap, the maximum outer diameter of the stud or the cap being at least less than one fifth of the maximum outer diameter of the gas-spring bellows.

A device may be provided which allows a gas spring to be installed in a simple manner and allows the spring bellows to rotate with respect to the suspension and/or the vehicle body during the initial installation and/or the initial operation.

### FIELD OF THE INVENTION

The present invention relates to a central fastening element for an axially symmetric, vehicle gas spring, which includes a bellows that has central bores or cutouts in the region of its end faces, the fastening element being fixed to the vehicle body, protruding from the surroundings of the attachment point in a direction normal to it, and being encompassed by the bores or cutouts.

### BACKGROUND INFORMATION

Such a device is described in European Published Patent Application No. 0 123 171. The gas spring includes, inter alia, a vertical U-bellows and two axially symmetric bodies terminating it on the upper and lower sides. On the upper side, the gas spring is fixed to the vehicle body, e.g., to the vehicle frame, with the aid of a bolt. This bolt is seated in a bore of the frame and is screwed to the axially symmetric upper body, a so-called plug. The U-bellows itself is fastened to the axially symmetric, upper member with the aid of a tension band. In this case, the diameter of the plug is as large as the inner diameter of the U-bellows.

This type of fastening requires that the bolthead on the upper side of the frame be accessible during installation. This makes it difficult to automate the installation of the gas spring. The gas spring tends to twist during installation, and while compressing and rebounding. Therefore, the tightening torque of the bolt must be selected to be high enough to prevent the connection between the gas spring and the vehicle body from loosening or releasing in response to vibrations and shock.

It is an object of the present invention to provide a fastening element, which renders simple installation possible and allows the bellows to rotate with respect to the suspension and/or the vehicle frame during the initial installation and/or the initial operation.

### SUMMARY

This object may be achieved by providing a fastening element as described herein. To this end, the fastening element may include a shaped stud or a shaped cap, the maximum outer diameter of the stud or the cap being at least less than one fifth of the maximum outer diameter of the gas-spring bellows. The cap or the stud has at least one necked-down portion or waist, whose outer diameter is less than the above-mentioned, maximum diameter of the cap or stud. The end face is elastic in the zone in which it comes into contact with the stud or the cap.

The central fastening element may be attached to the vehicle body prior to the installation of the gas spring and may protrude from the vehicle body in a direction normal to it. During installation, the gas spring is attached to, for example, the strut of the suspension and, e.g., pressed, together with it, against the shaped stud or the shaped cap. In the following, the term, stud, also includes the shaped cap. The elastic zone of the end face of the gas spring comes into contact with the stud in response to being slid up, and then engages with it in the manner of a snap fastener. The stud has a necked-down portion, which is encompassed by the bore or the cutout in a form-locked or force-locked manner.

This type of fastening may allow the gas spring to be installed in an automated manner. In this case, and during initial operation, the gas spring may rotate on the stud, which means that the twisting of the U-bellows and the increased wear caused by it are prevented. The keyed connection between the stud and spring prevents vibrations and shock from detaching the fastening element.

The base of the gas-spring bellows surrounds the stud axially and radially. Consequently, the gas spring is fixed in position in the axial and radial directions after installation. For example, it may not detach when the vehicle is jacked up, or in response to a pressure drop.

The gas spring may be attached at its upper and lower ends in the same manner. Supply lines may be run through the fastening element into the interior of the gas spring.

At least some regions of the base of the gas-spring bellows may be made of an elastic material, e.g., rubber. This may allow the base to act as a damping layer. The base may also be made up of multiple layers, e.g., a rubber layer and a metallic layer. In this case, the gas-spring bellows is attached to the metallic layer. The metallic layer is simultaneously used for increasing the strength of the gas-spring base. Several rubber and metallic layers may also be combined.

To attach the gas spring, e.g., this rubber layer is compressed between two surface sections of the stud oriented in opposite, axial directions, or between a surface section oriented in the direction of the vehicle body, and the vehicle body.

If the base of the gas spring is made out of multiple layers, the inner layer may be, for example, a metallic layer. The gas-spring bellows is then attached to this. This layer may be constructed in such a manner, that it supports the rubber layer and holds the position of the gas spring on the stud.

Further details of the fastening element according to the present invention are set forth below in the subsequent description of several schematically represented, example embodiments.

### BRIEF DESCRIPTION OF THE DRAWINGS

FIG. 1 schematically illustrates the attachment of a gas spring to a vehicle body.

FIG. 2 schematically illustrates an alternative manner of attaching a gas spring to a vehicle body.

FIGS. 3 to 7 schematically illustrate alternative example embodiments of the fastening elements for the arrangements illustrated in FIGS. 1 and 2.

### DETAILED DESCRIPTION

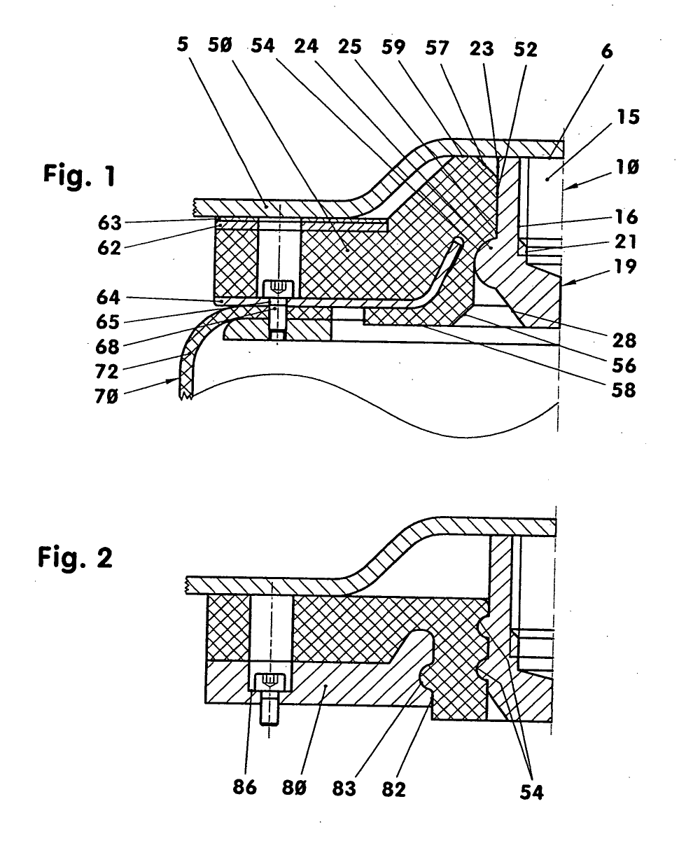

FIG. 1 illustrates the attachment of a gas spring 70 to a vehicle body 5, or to a strut. In this case, gas spring 70, e.g. an air spring, is made up of, inter alia, a U-bellows 72, which is attached to a damper plate 50. In this connection, damper plate 50 forms the base of gas-spring bellows 72. A fastening element 10 is mounted to vehicle body 5, e.g., to the vehicle frame, a body member, or a reinforced part of the body paneling.

On vehicle body 5, a bolt 15 is situated in a concave and, optionally, axial asymmetric depression 6. For example, this bolt 15 may be welded on. Bolt 15 has a thread 16. A mushroom-shaped cap 19 is screwed onto this thread 16 via an internal thread 21.

Cap 19 is axially asymmetric and has a cylindrical outer contour 23 in the upper region. In the middle region, the contour changes, e.g., discontinuously, into a circular arc 24. This transition is referred to in the following as 35 necked-down portion 25, undercut, or waist. In this case, the center point of circular arc 24 is, e.g., on the radius of cylindrical outer contour 23 or below it.

Curved section 24 is referred to below as a toroid. Cap 19 changes continuously or discontinuously between toroid 24 and a conical section 28 and tapers to approximately three quarters of its upper diameter.

Instead of being semicircular, the contour of the partial cross-section of toroid 24 may also be triangular. In the case of this contour, toroid 24 has a frustoconical lateral surface, whose imaginary apex points to the center of the U-bellows interior. For example, the bottom surface of this frustoconical apex discontinuously joins up with necked-down portion 25 to form a barb-shaped undercut.

The frustoconical apex may also be an imaginary enveloping surface for a series of resilient barbs positioned about cap 19. After installation, these barbs sink into optionally sharp-edged groove 54 of damper plate 50, while elastically recovering.

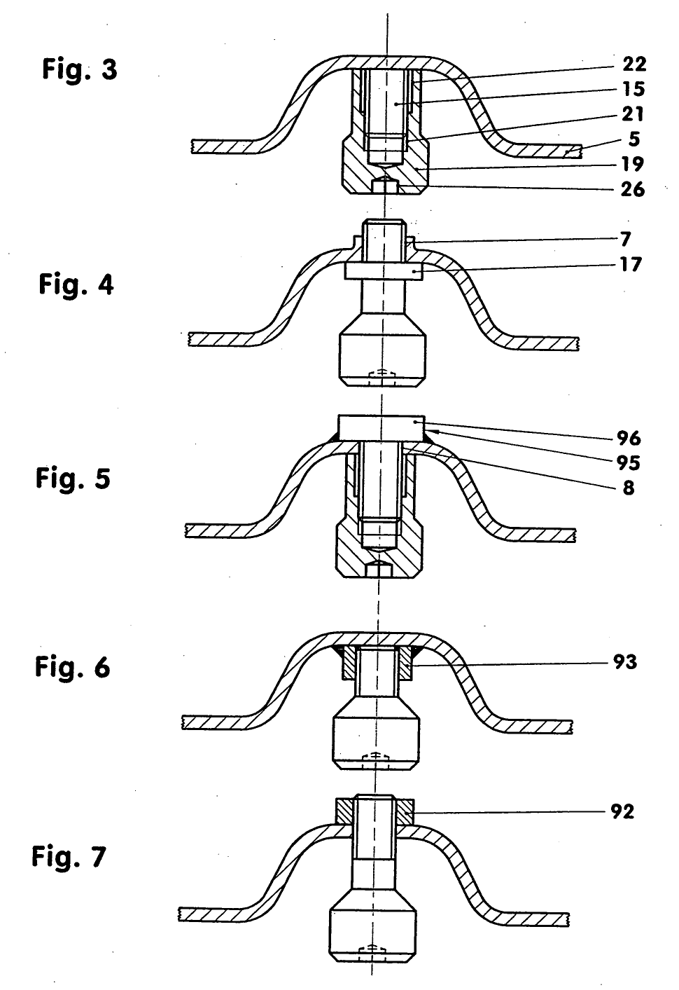

For example, a hexagonal recess 26 is centrally situated in cap 19, cf. FIG. 3.

Damper plate 50 is positioned around cap 19. The upper side of damper plate 50 is designated as outer side 59 and the lower side is designated as inner side 58. Cylindrical damper plate 50 is made of rubber and has a central bore 52, which is smaller that the maximum outer diameter of cap 19. A recess in the form of a circular groove 54 is situated approximately halfway up bore 52. This has a contour opposite to that of toroid 24 and therefore may ensure that damper plate 50 grips cap 19 from behind. In this connection, the region of damper plate 50 between groove 54 and outer side 59 may be compressed. Bore 52 changes into a chamfer 57 at the upper end face of damper plate 50. Damper plate 50 is also chamferred at the lower end face. The thickness of damper plate 50 in the middle region approximately corresponds to the length of cap 19, but the thickness in the outer region is reduced to approximately two thirds of the overall height. In this connection, inner side 58 is approximately planar.

A metallic disk 62 and a thin rubber layer 63 are situated on the outer side 59 of damper plate 50. The two parts may be cemented on or vulcanized on. A machined disk 64, whose central region is formed in the shape of a frustoconical shell in the direction of the center, is situated on inner side 58. The top edge of the frustoconical shell may be oriented, e.g., along groove 54 and may thus reinforce the rubber layer between bore 52 and machined disk 64. This improves, for example, the rear gripping action. For example, this machined disk 64 may be vulcanized into damper plate 50.

At least two bores 65 are situated in damper plate 50. These are cylindrical in the region of upper metallic disk 62, thin rubber layer 63 and damper plate 50. The diameter of bores. 65 in machined disk 64 is adapted to cover bolts 68. Gas-spring bellows 72 is attached to damper plate 50 by these cover bolts 68. Damper plate 50 rests against vehicle body 5 in the region of vehicle-frame depression 6, and in the region of rubber sheet 63.

FIG. 2 illustrates an alternative manner of attaching gas spring 70 to vehicle body 5. As in the exemplary embodiment illustrated in FIG. 1, a bolt 15 having external thread 16 is situated in a depression 6 of vehicle body 5.

A cap 19 is screwed onto a bolt 15. In this case, this cap 19 has two circumferential toroids 24 at the transition from conical part 28 to cylindrical outer contour 23, the outer diameter being greater in the region of the cap 19 of the two circumferential toroids than in the region of cylindrical outer contour 23. The spacing of the two toroids 24 is, for example, approximately as large as half the difference of the diameter of a toroid 24 and cylindrical outer contour 23. Conical part 28 of cap 19 is tapered in the downward direction.

Damper plate 50 of gas spring 70 is a cylindrical, axially symmetric rubber sheet, which has a central bore 52. Bore 52 has two circumferential grooves 54. These have a contour opposite to that of toroids 24 and therefore may ensure that damper plate 50 elastically grips cap 19 from behind. In this connection, the region of damper plate 50 between grooves 54 is optionally compressed.

In the region of the cap, the thickness of damper plate 50 corresponds to approximately two-thirds of the length of cap 19. In this case, outer side 59 of damper plate 50 is planar.

Situated in damper plate 50 is a, e.g., metallic, machined disk 80, which may be vulcanized in. It has a central bore 82. Near the bore 82, the thickness of this machined disk 80 is approximately twice as much as in the remainder of machined disk 80. The diameter of bore 82 is approximately one third of the overall diameter of machined disk 80. A recess 83 is situated approximately in the center of this cylindrical bore 82. Damper plate 50 engages with the former and thus allows axial, form-locked engagement. Bore 82 of machined disk 80 surrounds damper plate 50 to provide stiffness in the region of grooves 54.

Machined disk 80 has at least two countersunk bores 86 in the outer region. Cover bolts 68 are situated in these countersunk bores 86, cf. FIG. 1. In the exemplary embodiment illustrated in FIG. 2, metallic disks 62, 64 and/or rubber disks 63 illustrated in FIG. 1 may also be vulcanized into damper plate 50.

In the two exemplary embodiments, gas-spring bellows 72 pre-mounted to damper plate 50 is installed in the designated position. In this connection, central bore 52 of damper plate 50 is aligned with and centered on cap 19. Chamfer 57 of bore 52 is then seated on conical part 28 of cap 19. For installation purposes, damper plate 50 is pushed, optionally together with spring bellows 72, against cap 19, and pushed over toroid(s) 24, as damper plate 50 elastically expands. Cap in this case, grooves 54 rest against toroid(s) 24.

During the automatic assembly of the axle, this gas spring 70 may be snapped into place in the nonpressurized state. Additional fastening measures, such as bonding or the application of a torque, may not be necessary for installation. In addition, a special tool may not be required for the installation or the detachment of gas spring 70 in the exemplary embodiments.

During installation, gas spring 70 centers itself on cap 19, using chamfer 57 of damper plate 50. No torsional stress is generated in spring bellows 72 in response to it being filled with gas, since spring 70 may align itself about fastening element 10. Due to its rear engagement, gas spring 70 may not detach from its mounting in response to a drop in pressure.

If gas spring 70 is equipped, on its end faces, with one of the mountings described in the exemplary embodiments, upper or lower damper plate 50 of gas spring 70 may also be arranged to have a blind hole in place of a bore 52. In this case, the sealing of the interior of gas spring 70 may be eliminated in the region of attachment.

Damper plate 50 may also be part of spring bellows 72. In this case, the need for pre-mounting spring bellows 72 to damper plate 50 may be eliminated. In this exemplary embodiment, the need for the upper and/or lower gaskets in the region of the cover bolts may be eliminated.

The rubber-elastic seating of damper plate 50 on vehicle body 5 allows it to acoustically decouple vehicle body 5 from the suspension.

FIGS. 3 to 7 illustrate exemplary embodiments of the form and the attachment of bolt 15, i.e., of the shaped stud, and cap 19 to vehicle frame 5.

In FIG. 3, bolt 15 is welded, for example, to vehicle frame 5. Bolt 15 may also be arranged as a sleeve. Cap 19 has a cylindrical inner bore 22. As seen from above, the final third of inner bore 22 is arranged to be a tapped hole 21.

In FIG. 4, stud 15 is screwed into a thread in vehicle frame 5. To secure the connection, stud 15 is braced against vehicle frame 5 at collar 17.

FIG. 5 illustrates a bolt 95, which is inserted from above, through a bore 8 of vehicle frame 5. Bolt 95 may have a special head shape. Head 96 of bolt 95 is welded to vehicle frame 5 from the top. Cap 19 is screwed onto bolt 15 from below. In this case, this cap 19 has the same exemplary embodiment as in FIG. 3. Cap 19 is fastened to bolt 95 by bracing it.

In FIG. 6, a nut 93 is welded to vehicle frame 5. Stud 15 is screwed into the nut. In this connection, stud 15 may be arranged to have or not have a collar. When stud 15 is constructed without a collar, stud 15 is secured by bracing stud 15 against the root of the thread. When stud 15 has a collar, stud 15 is secured by bracing the shaft collar against nut 93.

FIG. 7 corresponds to FIG. 6, the difference being that a weld nut 92 is attached to the upper side of vehicle frame 5. Stud 15 is secured, for example, by tack-welding it to weld nut 92, or by cold-working the ends of the thread, e.g., using a special tool.

Other attachment variations are possible. These may combine, for example, the elements described above.

1-9. (canceled)

10. A central fastening element for an axially symmetric, vehicle gas spring including a bellows having one of central bores and cutouts in a region of an end face, the fastening element configured to be fixed to a vehicle body and to protrude from surroundings of an attachment point in a normal direction and to be encompassed by the one of the bores and cutouts, comprising:
at least one of a stud and a cap, one of the at least one of the stud and the cap shaped, a maximum outer diameter of the one of the stud and the cap at least less than one fifth of a maximum outer diameter of the bellows, the one of the stud and the cap including at least one necked-down portion having a diameter less than the maximum outer diameter of the one of the stud and the cap, the end face elastic in a zone of contact with the one of the stud and the cap.

11. The fastening element according to claim 10, wherein a base of the bellows axially and radially surrounds the one of the stud and the cap without a sealing joint.

12. The fastening element according to claim 10, further comprising an integrated supply line.

13. The fastening element according to claim 10, wherein the cap includes an internal thread, the stud having an external thread, the cap substantially completely surrounding the stud, the cap arranged to one of directly and indirectly contact the vehicle body.

14. The fastening element according to claim 10, wherein the stud is arranged to be screwed into a tapped hole of the vehicle body, the stud having a surface oriented in a direction normal to an axis of the stud, the surface arranged to one of directly and indirectly rest against the vehicle body.

15. The fastening element according to claim 10, wherein the stud is arranged to be screwed into a nut fastened to the vehicle body.

16. The fastening element according to claim 10, wherein a base of the bellows includes at least two superposed layers, at least one of the layers made of metal, at least one of the layers made of metal.

17. The fastening element according to claim 10, wherein a base of the bellows is arranged to rest against at least two surface sections of the one of the stud and the cap oriented in axially opposite directions.

18. The fastening element according to claim 10, wherein a base of the bellows is arranged to rest against a surface section of the one of the stud and the cap oriented in a direction of the vehicle body and against the vehicle body in a region of attachment of the one of the stud and the cap.

19. The fastening element according to claim 10, wherein the cap includes an internal thread, the stud having an external thread, the cap substantially completely surrounding the stud, the cap one of directly and indirectly contacting the vehicle body.

20. The fastening element according to claim 10, wherein the stud is screwed into a tapped hole of the vehicle body, the stud having a surface oriented in a direction normal to an axis of the stud, the surface one of directly and indirectly resting against the vehicle body.

21. The fastening element according to claim 10, wherein the stud is screwed into a nut fastened to the vehicle body.

22. The fastening element according to claim 10, wherein a base of the bellows rests against at least two surface sections of the one of the stud and the cap oriented in axially opposite directions.

23. The fastening element according to claim 10, wherein a base of the bellows rests against a surface section of the one of the stud and the cap oriented in a direction of the vehicle body and against the vehicle body in a region of attachment of the one of the stud and the cap.

24. The fastening element according to claim 10, wherein the fastening element is fixed to a vehicle body.

25. The fastening element according to claim 10, wherein the fastening element protrudes from the surroundings of the attachment point in the normal direction.

26. The fastening element according to claim 10, wherein the fastening element is encompassed by the one of the bores and cutouts.

27. A device, comprising:
an axially symmetric, vehicle gas spring including a bellows having one of central bores and cutouts in a region of an end face; and
a fastening element configured to be fixed to a vehicle body and to protrude from surroundings of an attachment point in a normal direction, the fastening element encompassed by the one of the bores and cutouts, the fastening element including at least one of a stud and a cap, one of the stud and the cap shaped, a maximum outer diameter of the one of the stud and the cap at least less than one fifth of a maximum outer diameter of the bellows, the one of the stud and the cap including at least one necked-down portion having a diameter less than the maximum outer diameter of the one of the stud and the cap, the end face elastic in a zone of contact with the one of the stud and the cap.
